(19) United States
(12) Patent Application Publication
(10) Pub. No.: US 2012/0293654 A1
(43) Pub. Date: Nov. 22, 2012

(54) IMAGE TRANSMISSION APPARATUS, IMAGE TRANSMISSION METHOD THEREOF, AND STORAGE MEDIUM

(75) Inventor: Itaru Ikegami, Kawasaki-shi (JP)

(73) Assignee: CANON KABUSHIKI KAISHA, Tokyo (JP)

(21) Appl. No.: 13/468,794

(22) Filed: May 10, 2012

(30) Foreign Application Priority Data
May 17, 2011 (JP) 2011-110642

(51) Int. Cl. H04N 7/18

(52) U.S. Cl. 348/143; 348/E07.085

(57) ABSTRACT

An image transmission apparatus configured to transmit a captured image captured by an imaging unit to a display apparatus via a network includes a detection unit configured to detect that an image capturing direction of the imaging unit reaches a reference direction, a limiting unit configured to limit display of an entire or partial region of the captured image, a providing unit configured to provide information for composing a screen to be used for displaying the captured image on the display apparatus, and a control unit configured to cause the limiting unit to limit display of an entire or partial region of the captured image captured during a detection period after starting of changing of the image capturing direction and before detecting that the image capturing direction reaches the reference direction, and to allow providing the information for composing the screen during a period including the detection period.

### BACKGROUND OF THE INVENTION

1. Field of the Invention

The present invention relates to an image transmission apparatus that transmits a captured image captured by a camera via a network, an image transmission method thereof, and a storage medium that stores a computer readable program.

2. Description of the Related Art

Conventionally, a camera having a mask function in which a mask image is superimposed on a captured image captured by a camera for the purpose of protecting a privacy of an object has been known. A camera that can change an image capturing direction and can preliminary set a region on which the mask image is superimposed in an image capturing region that can be captured by the camera has been known among cameras having the mask function. In a case where such a camera superimposes the mask image on the captured image, it is necessary to find an accurate image capturing direction of the camera in order to define a region on which the mask image is superimposed in the captured image captured in the current image capturing direction.

As a method for acquiring the accurate image capturing direction of the camera, a method in which reference positions for panning and tilting are detected by using, for example, sensors at a predetermined time such as a startup of the camera and the image capturing direction is calculated based on a panning drive amount from the reference position for panning and a tilting drive amount from the reference position for tilting has been known. In the above-described method, however, the reference positions need to be searched for by performing a panning drive and a tilting drive in order to detect each of the reference position for panning and the reference position for tilting. Therefore, it takes time after the start of the panning drive and the tilting drive for the purpose of searching for the reference positions and before the detection of the reference positions. Since the image capturing direction cannot be defined accurately during a period between time at which the panning drive and the tilting drive are started and time at which the image capturing direction of the camera is defined, the mask image cannot be superimposed on a correct position on the captured image. Consequently, a privacy of an object cannot be protected sufficiently during that period.

To solve the above-described problem, Japanese Patent Application Laid-open No. 2009-135683 discusses a camera that performs blurring on an object during a period before a state that a driving unit for performing a panning drive and a driving unit for performing a tilting drive reach predetermined reference positions, respectively, is detected. Accordingly, the camera discussed in Japanese Patent Application Laid-open No. 2009-135683 protects a privacy of an object during the detection of the reference positions.

However, the conventional camera only outputs a captured image captured by the camera to a display apparatus. In the conventional camera, a case of a transmission of the captured image in response to an image transmission request from the display apparatus is not considered.

### SUMMARY OF THE INVENTION

According to an aspect of the present invention, an image transmission apparatus configured to transmit a captured image captured by an imaging unit to a display apparatus via a network includes a detection unit configured to detect that an image capturing direction of the imaging unit changed by a changing unit configured to change the image capturing direction reaches a reference direction, a limiting unit configured to limit display of an entire or partial region of the captured image, a providing unit configured to provide, to the display apparatus, information for composing a screen to be used for displaying the captured image on the display apparatus via the network, and a control unit configured to cause the limiting unit to limit display of an entire or partial region of the captured image captured during a detection period after the changing unit starts changing of the image capturing direction and before the detection unit detects that the image capturing direction reaches the reference direction, and to allow the providing unit to provide the information for composing the screen during a period including the detection period.

According to an exemplary embodiment of the present invention, in a case where a camera transmits a captured image in response to an image transmission request from a display apparatus, the camera can transmit the captured image while protecting a privacy of an object even while the camera searches for a reference direction for defining the image capturing direction.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A illustrates a configuration of a camera according to a first exemplary embodiment of the present invention. FIG. 1B illustrates configurations of a driving unit and a drive control unit of the camera according to the first exemplary embodiment of the present invention.

FIG. 2 is a sequence diagram illustrating an operation of the camera according to the first exemplary embodiment of the present invention.

FIG. 3 illustrates how to superimpose a mask image in the first exemplary embodiment or a second exemplary embodiment of the present invention.

FIG. 4 is an operation flow chart illustrating an operation of a central processing unit (CPU) in the first exemplary embodiment of the present invention.

FIG. 5 is an operation flow chart illustrating an operation of a camera control unit in the first exemplary embodiment of the present invention.

FIG. 6 is a sequence diagram illustrating an operation of a camera according to a second exemplary embodiment of the present invention.

FIG. 7 illustrates an image transmission system according to the first exemplary embodiment or the second exemplary embodiment of the present invention.

### DESCRIPTION OF THE EMBODIMENTS

Various exemplary embodiments, features, and aspects of the invention will be described in detail below with reference to the drawings.

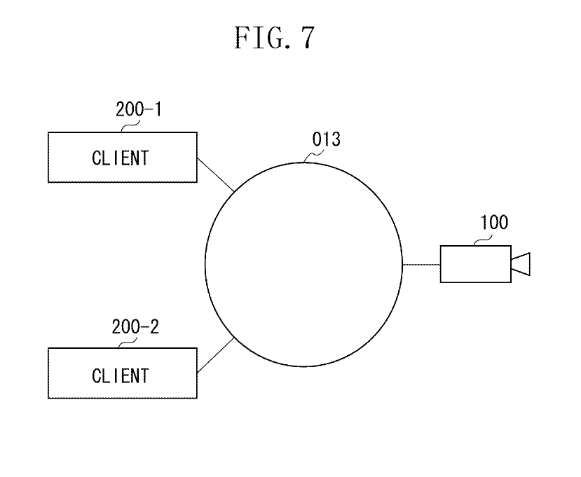

In an image transmission system according to a first exemplary embodiment of the present invention, as illustrated in FIG. 7, a camera 100 is connected to a plurality of clients 200 (200-1 and 200-2) via a network 013. The network 013 is composed of, for example, a plurality of routers, switches, and cables which satisfy a transmission standard of, for example, the Ethernet. In the present exemplary embodiment, any transmission standard, size, and configuration can be employed for the network 013 as far as it can establish a server-client communication. The internet, a local area network (LAN), and the like may also be employed. The camera 100 captures an image of an object and distributes the captured image to the clients 200 via the network 013.

Each of the clients 200 issues a request, e.g., an image transmission request and a setting request, to the camera 100. In the image transmission system according to the present exemplary embodiment, a client 200-1 having an administrator authority (hereinafter referred to as “administrator client”) is connected to the camera 100 via the network 013 as a first client. Further, a client 200-2 having a general client authority (hereinafter referred to as “general client”) (hereinafter the administrator client 200-1 and the general client 200-2 are collectively referred to as “clients 200”) is connected to the above camera 100 via the network 013 as a second client. Still further, each of the clients 200 takes a roll of a display apparatus for displaying a captured image distributed from the camera 100 in response to the image transmission request.

The administrator client 200-1 can execute a setting application (hereinafter referred to as a “setting tool”) that changes settings of the camera 100. The administrator client 200-1 issues a setting request to the camera 100 by using the setting tool to change the settings of the camera 100. The administrator client 200-1 can change the settings, e.g., a mask setting, a visibility setting, and a preset position setting, with respect to the camera 100 by using the setting tool. The above-described settings are mere examples and thus what can be set by the setting tool is not limited to the above exemplified settings. It is not necessary to allow the setting tool to set all the above exemplified settings.

The administrator client 200-1 can issue the image transmission request to the camera 100 and can request the camera 100 to distribute a captured image captured by the camera 100 to the clients 200. The administrator client 200-1 can receive a captured image that is not limited by the mask setting, the visibility setting, and the preset position setting when the administrator client 200-1 receives a video distribution from the camera 100 by using a viewer for the administrator (hereinafter referred to as “administrator viewer). More specifically, the administrator client 200-1 can display a captured image on which a mask image is not superimposed by using the administrator viewer. The administrator client 200-1 also can display a captured image by changing the image capturing direction of the camera 100 without the image capturing direction of the camera 100 being limited to a preset position or being limited in a range of a predetermined movable region.

In a case where the administrator client 200-1 receives the video distribution by using the administrator viewer, the administrator client 200-1 initially displays the captured image of a range designated according to, for example, the visibility setting after the mask image set by the mask setting is superimposed on the captured image. However, in a case where the administrator client 200-1 receives the video distribution by using the administrator viewer, the administrator client 200-1 can also display a video image outside the range on which the visibility setting is set by panning and tilting the camera 100. When the administrator client 200-1 changes the settings by using the setting tool, the administrator client 200-1 can display a captured image that is not limited by the pre-set settings by using the administrator viewer.

The general client 200-2 issues an image transmission request to the camera 100 and requests the camera 100 to distribute a captured image captured by the camera 100 to the clients 200. The general client 200-2 has a general client authority to receive a captured image that is limited by, for example, the mask setting, the visibility setting, and the preset position setting, when the general client 200-2 receives the video distribution from the camera 100. The general client 200-2 cannot use the setting tool. Therefore, the general client 200-2 cannot issue the setting request to the camera 100, i.e., cannot change the settings of the camera 100.

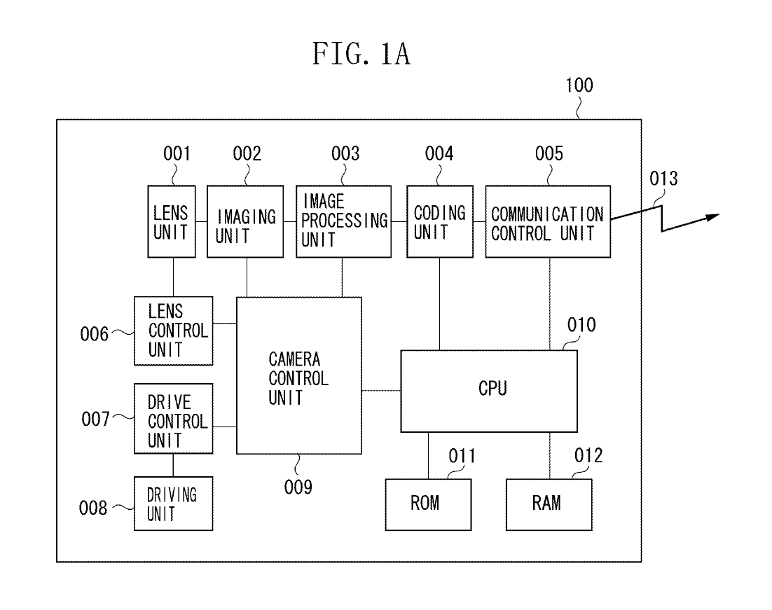

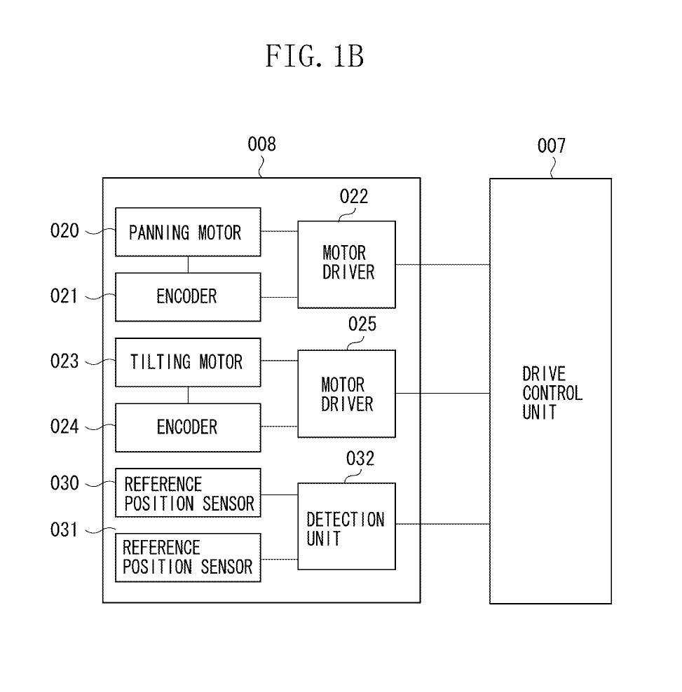

Now, a configuration of the camera 100 according to the present exemplary embodiment is described below with reference to FIG. 1A. A lens unit 001 forms an image of the object on an imaging unit 002. In the present exemplary embodiment, the lens unit 001 can perform zooming and an adjustment of a diaphragm according to control of a lens control unit 006.

The imaging unit 002 includes an image sensor such as a complementary metal-oxide semiconductor (CMOS) sensor and converts the image formed by the lens unit 001 into an image signal.

An image processing unit 003 receives the image signal output from the imaging unit 002 and superimposes a mask image on the captured image after the captured image is subjected to development processing. The image processing unit 003 may perform pixelization, blurring, and superimposition of characters, symbols, and the like according to an on-screen display (OSD) in addition to the superimposition of the mask image.

A coding unit 004 encodes the data output from the image processing unit 003 by using encoding formats such as the Joint Photographic Experts Group (JPEG), the Moving Picture Experts Group phase 4 (MPEG-4), and H.264. A communication control unit 005 transmits the image data encoded by the coding unit 004 to the network 013.

The lens control unit 006 controls zooming, the diaphragm, and the like of the lens unit 001 in order to receive an adequate image. The lens control unit 006 includes a stepper motor for zoom adjustment and a motor driver for outputting a pulse signal for driving the stepper motor. The lens control unit 006 includes a stepper motor for diaphragm adjustment and a motor driver.

The drive control unit 007 controls a driving unit 008. The driving unit 008 changes the image capturing direction of the camera 100. The drive control unit 007 and the driving unit 008 are described below with reference to FIG. 1B. A panning motor 020 and a tilting motor 023 drive the image capturing direction of the camera 100 in each of a panning direction and a tilting direction. Encoders 021 and 024 detect revolving speeds of the panning motor 020 and the tilting motor 023, respectively. A motor driver 022 drives the panning motor 020 based on the detection result of the encoder 021. A motor driver 025 drives the tilting motor 023 based on the detection result of the encoder 024.

Each of a reference position sensor 030 and a reference position sensor 031 detects a reference position for performing each of the panning drive and the tilting drive. The drive control unit 007 sets the image capturing direction in which the camera 100 is capturing the image at the time the reference position sensor 030 and the reference position sensor 031 detect the reference positions as reference directions. The drive control unit 007 defines the image capturing direction of the camera 100 based on the drive amount of the driving unit 008 from the reference positions and the reference directions. The drive amount of the driving unit 008 from the reference positions corresponds to a change amount corresponding to the amount that the driving unit 008 changes the image capturing direction from the reference directions. The drive control unit 007 outputs the information of the defined image capturing direction of the camera 100 to a camera control unit 009 and a CPU 010. How to specify the image capturing direction is described below in detail.

For example, Hall elements can be used as the reference position sensors. In this case, each of the reference position sensor 030 and the reference position sensor 031 outputs a detection signal to a detection unit 032 when each of the reference position sensor 030 and the reference position sensor 031 senses a magnetic field of a magnet positioned at each of the reference position for panning and the reference position for tilting. The detection unit 032 detects the reference position for panning and the reference position for tilting based on the detection signal of the reference position sensor 030 and the detection signal of the reference position sensor 031. The detection unit 032 detects that the image capturing direction is oriented to the reference direction of the panning direction by detecting the reference position for panning. Similarly, the detection unit 032 detects that the image capturing direction is oriented to the reference direction of the tilting direction by detecting the reference position for tilting. Accordingly, the detection unit 032 searches for a predetermined reference direction of each of the panning direction and the tilting direction according to the drive of the driving unit 008 and detects that the image capturing direction of the camera 100 reaches each reference direction. The drive control unit 007 controls a motor driver 022 and a motor driver 025 based on the detection result of the detection unit 032.

The camera control unit 009 controls the imaging unit 002, the lens control unit 006, and the image processing unit 003. The camera control unit 009 controls the lens control unit 006 by managing a revolving speed and an electronic zoom magnification of the stepper motor for defining a zoom level in the lens unit 001. The revolving speed of the stepper motor is determined by the number of pulses output to the stepper motor. The camera control unit 009 performs control to output the captured image to the coding unit 004 after subjecting the captured image to the image processing by the image processing unit 003. The camera control unit 009 notifies a notification to the effect that image capturing is completed in the imaging unit 002 and the captured image is ready to be output to the network 013 to the CPU 010. The camera control unit 009 notifies a notification of a completion of the superimposition of the mask image to the CPU 010 when the mask image is superimposed on the captured image by the image processing unit 003.

The CPU 010 controls the camera control unit 009, the coding unit 004, and the communication control unit 005.

The CPU 010 perform control to permit providing the client with configuration information of a screen that is used by the client in order to perform setting and the operation (hereinafter referred to as a “setting operation screen”) with respect to the camera 100. In other words, the CPU 010 performs control for permitting reading-out of the configuration information of the setting operation screen preliminary stored in a read-only memory (ROM) 011 and providing the thus read-out configuration information to the client.

The CPU 010 performs control for providing the client with the configuration information of the setting operation screen in response to an access from the client. For example, the client opens the web browser to access the camera 100 via the network 013. The client can issue a request for receiving the configuration information of the setting operation screen from the camera 100 to the camera 100 by inputting a specific IP address into the web browser.

When the CPU 010 of the camera 100 receives an access from the client, the CPU 010 of the camera 100 provides the client with the configuration information for composing the setting operation screen of the camera 100. The client generates the setting operation screen based on the configuration information received from the camera 100 to display the thus generated screen on the web browser.

The client can open the administrator viewer or a public viewer from the setting operation screen. As described above, in a case where the administrator client 200-1 receives the video distribution by using the administrator viewer, the administrator client 200-1 can display the video image outside the range to which visibility is set. On the other hand, in a case where the administrator client 200-1 receives the video distribution by using the public viewer, the administrator client 200-1 can display the video image in the range on which the mask image set by the mask setting is superimposed or can display the video image inside the range designated by, for example, the visibility setting. More specifically, the public viewer can display an image limited by the setting that limits display of an entire or partial region of the image.

In order to open the administrator viewer from the setting operation screen, for example, entry of a user name or a password may be required. As described above, only a specific client can display an image in which the display of the video image is not limited by using the administrator viewer.

Accordingly, the camera 100 provides the client with the configuration information for causing the client to display the administrator viewer or the public viewer in response to an instruction input via the setting operation screen.

The client further can start the above-described setting tool via the setting operation screen. In order to start the setting tool, for example, entry of a user name or a password may be requested. Accordingly, only a specific client can make the setting of the camera 100 by using the setting tool.

In the present exemplary embodiment, the CPU 010 determines an authority of a client who has issued the image transmission request to the camera 100. The CPU 010 distributes the video image in which a display of the region on which the mask image is superimposed is limited according to the authority of the client and distributes the video image in which the display is not limited.

For example, the CPU 010 determines that the client has the administrator authority in a case where the client issues the image transmission request by using the above-described administrator viewer. The CPU 010 distributes the video image in which the display is not limited to the client who has issued the image transmission request by using the administrator viewer.

On the other hand, in a case where the image transmission request is issued from a viewer other than the administrator viewer, the CPU 010 determines that the client has no administrator authority. The CPU 010 distributes the video image in which the display is limited to the client. Alternatively, the camera 100 can preliminary store authority information indicating the authority of each client connected to the camera 100 via the network 013 in the ROM 011 or the RAM 012. The CPU 010 can determine whether the client who has issued the image transmission request has the administrator authority with reference to the authority information. The method in which the CPU 010 determines the authority of a client is not limited to the above.

In the present exemplary embodiment, the CPU 010 performs control such that the captured image output from the image processing unit 003 is not output to the general client 200-2 during a period after the driving unit 008 starts driving to search for the reference directions and before the CPU 010 receives the information of the image capturing direction from the drive control unit 007. As described above, after the detection unit 032 detects that the image capturing direction of the camera 100 reaches the reference directions, the drive control unit 007 defines the image capturing direction of the camera 100 based on the detected reference directions to output the information of the image capturing direction to the CPU 010. Therefore, the CPU 010 can receive the information of the image capturing direction with respect to the captured image captured after the detection unit 032 detects that the image capturing direction of the camera 100 reaches the reference directions.

As described above, the captured image captured before the detection unit 032 detects the reference directions is not output to the general client 200-2. The CPU 010 performs control such that the captured image captured during a period after the driving unit 008 starts driving to search for the reference direction and before the detection unit 032 detects that the image capturing direction of the camera 100 reaches the reference directions is not transmitted to the general client 200-2.

In the present exemplary embodiment, a case where the captured image captured before the detection unit 032 detects the reference directions is not output to the general client 200-2 is described. However, the present exemplary embodiment is not limited thereto. The present exemplary embodiment may be configured such that the captured image captured before the detection unit 032 detects the reference directions is not output to either one of the administrator client 200-1 or the general client 200-2.

The ROM 011 stores a program to be executed by the CPU 010. The ROM 011 includes, for example, a flash memory. The ROM 011 retains data even after the power is disconnected, so that the ROM 011 also takes a roll of storage. The RAM 012 stores programs and data. The above-described blocks are mutually connected via a dedicated bus or a common bus as illustrated in FIGS. 1A and 1B.

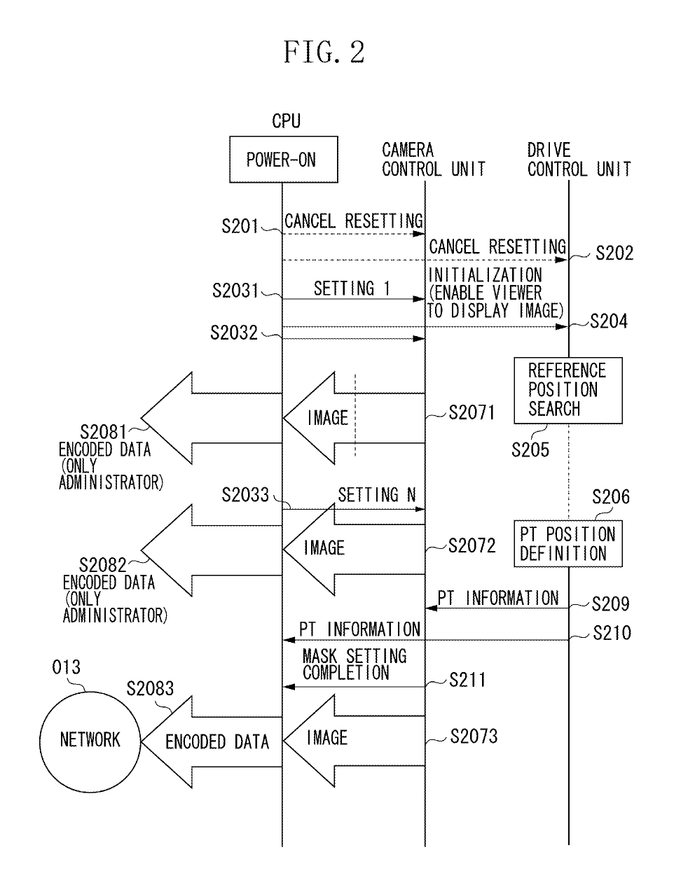

Image transmission control when the power of the camera 100 is turned on is described below with reference to FIG. 2. In step S201, when the power is turned on, the CPU 010 cancels resetting of the camera control unit 009. In step S202, the CPU 010 also cancels resetting of the drive control unit 007.

In steps S2031 through S2033, the CPU 010 subsequently makes an initial setting with respect to the camera control unit 009. In the present exemplary embodiment, the CPU 010 makes the initial setting with respect to the camera control unit 009 by reading out a setting value of the initial setting from the ROM 011. In the present exemplary embodiment, the setting value of the initial setting is preliminary set by the administrator client 200-1 by using the setting tool. The initial setting includes a setting with respect to the region on which the mask image is to be superimposed by the image processing unit 003 according to the control of the camera control unit 009 (hereinafter referred to as a “superimposed region”) in the image capturing region that can be captured by the camera 100.

In the present exemplary embodiment, a case where the predetermined region in the captured image is restricted so as not to be displayed by the client by superimposing the mask image on the captured image. However, the restricting method is not limited thereto. For example, the restricted region to be restricted so as not to be displayed by the client is restricted according to blurring and the like, the restricted region being in the image capturing region capable of being captured by the camera 100. In the case of performing pixelization or superimposition of characters, symbols, and the like on the captured image by the OSD in addition to the superimposition of the mask image, the initial setting may be further made with respect to such processing. Information of the superimposed region as the initial setting value of the superimposed region is stored in the ROM 011.

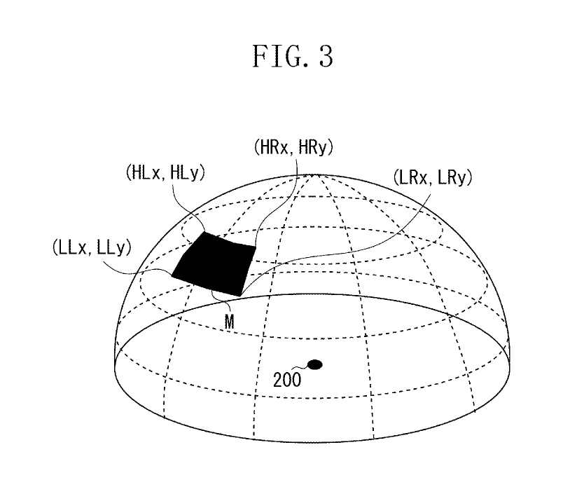

As illustrated in FIG. 3, the superimposed region superimposed by the mask image can be set by using the coordinates (HLx, HLy), (LLx, LLy), (HRx, HRy), and (LRx, LRy) of apexes of a mask image M in the camera view around a position 200 of the camera 100. In a case where the mask image has a square shape, it is not necessary to acquire all the coordinates of the four apexes of the square shape. The coordinates of the two apexes on a diagonal line of the square shape enable defining the superimposed region superimposed by the mask image. Alternatively, the superimposed region can be set with the coordinates of any one of the points on the mask image, such as a lower left apex of the mask image and the center of the mask image, and a height and a width of the mask image. In the initial setting, a plurality of mask regions can be set on a range of the camera view.

The CPU 010 makes the initial setting including, for example, a light metering scheme setting, a shutter speed setting, and a setting as to the presence or absence of a backlight correction with respect to the camera control unit 009 in addition to the setting of the superimposed region of the mask image. The initial setting is not limited thereto. The CPU 010 can read out the initial setting stored in the ROM 011 when the power is turned on to make a setting with respect to the camera control unit 009.

In step S204, the CPU 010 issues an initialization instruction to the drive control unit 007 when the power is turned on. As illustrated in FIG. 2, the CPU 010 can issue the initialization instruction to the drive control unit 007 while the CPU 010 sequentially makes the setting of the initial setting with respect to the camera control unit 009. An order of making the initial setting with respect to the camera control unit 009 and providing the initialization instruction to the drive control unit 007 is transposable.

When the drive control unit 007 receives the initialization instruction from the CPU 010, in step S205, the drive control unit 007 drives the driving unit 008 to execute the search of the reference direction for each of panning and tilting. How to search for the reference directions according to the control of the drive control unit 007 is described below. The reference directions are searched for by searching for a reference position for panning and a reference position for tilting. In the panning operation, an output pulse signal of the encoder 021 for detecting the revolution of the panning motor 020 is transmitted to the drive control unit 007 according to the panning drive of the driving unit 008. A detected point of the reference position for panning detected by the reference position sensor 030 is transmitted to the drive control unit 007 via the detection unit 032. The drive control unit 007 sets the image capturing direction of the camera 100 at the time that the reference position sensor 030 detects the reference position for panning as the reference direction of the panning.

The drive control unit 007 counts the number of pulses m output by the encoder 021 after the detection unit 032 detects the reference position for panning based on the detection signal of the reference position sensor 030. The drive control unit 007 subsequently calculates a panning angle Pi from the reference position by the following equation (1). The calculated current panning angle Pi is stored in the RAM 012.

Pi=m×360/p (1)

Here, p represents the number of pulses output from the encoder 021 in a case where the image capturing direction of the camera 100 is panned by 360°. The tilting angle also can be calculated in a similar manner as it is done for calculating the panning angle.

As described above, the drive control unit 007 calculates the drive amount of the driving unit 008 from the reference positions. The drive control unit 007 defines the current image capturing direction of the camera 100 based on the reference directions and the calculated drive amount. The drive control unit 007 may change the image capturing direction of the camera 100 in a direction upon starting the drive thereof in order to search for the reference directions when the detection unit 032 detects that the image capturing direction of the camera 100 reaches the reference directions. In this case, the drive control unit 007 can count and store the number of pulses representing the drive amounts of the panning motor 020 and the tilting motor 023 during the period after starting the search of the reference directions and before detecting the reference directions. Accordingly, the drive control unit 007 can define the image capturing direction at the time of starting the search by using the equation (1) at the time that the detection unit 032 detects that the image capturing direction of the camera 100 reaches the reference directions.

In step S206, the search of the reference directions is completed and the panning/tilting position is defined. In step S209, the drive control unit 007 transmits the information of the defined panning/tilting position to the camera control unit 009. In step S210, the drive control unit 007 subsequently transmits the information of the defined panning/tilting position to the CPU 010.

In steps S2071 through S2073, the camera control unit 009 sequentially receives the initial value and notifies a notification to the effect that the captured image is ready to be output when it becomes a state that the captured image can be output. The CPU 010 controls the communication control unit 005 such that the captured image having received the above notification in steps S2071 and S2072 before receiving the information of the defined panning/tilting position from the drive control unit 007 is not output to the general client 200-2.

The drive control unit 007 defines, after the detection unit 032 detects that the image capturing direction of the camera 100 reaches the reference positions, the panning/tilting position of the camera 100 based on the detected reference directions. Therefore, the drive control unit 007 can output the information of the defined panning/tilting position with respect to the captured image captured after the reference directions are detected. As described above, the CPU 010 performs control such that the image data of the captured image captured during a period after the driving unit 008 starts driving to search for the reference directions and before the detection unit 032 detects that the image capturing direction of the camera 100 reaches the reference directions is not transmitted to the general client 200-2. For example, in a case where the image distribution request from the client is not issued by using the administrator viewer, the CPU 010 determines that the image distribution request is issued from the client 200-2. Alternatively, for example, the CPU 010 determines whether the client who has issued the image distribution request has the administrator authority based on the authority information of each client preliminary stored in the camera 100. A method in which the CPU 010 determines the authority of the client is not limited to the above.

An example of the method in which the image data of the captured image is not transmitted to the general client 200-2 includes a method in which the CPU 010 can instruct the communication control unit 005 to make a response to reject the execution thereof to the image distribution request from the general client 200-2. For example, in a case where the Hypertext Transfer protocol (HTTP) is used as a communication protocol for communicating with the clients, the CPU 010 can cause the communication control unit 005 to make a response of a status code of “403 Forbidden” to the client to reject the execution of the image transmission request.

Alternatively, the CPU 010 may receive the image distribution request from the general client 200-2 but does not transmit the image data to the general client 200-2 until the image data of the captured image becomes ready to be transmitted. In other words, the CPU 010 may cause the general client 200-2 to wait until the image data of the captured image becomes ready to be transmitted. For example, in a case where the HTTP is used as the communication protocol, the CPU 010 causes the communication control unit 005 to make a response of a status code of “200 OK” and, when the image data of the captured image becomes ready to be transmitted, the CPU 010 causes the communication control unit 005 to distribute the image to the general client 200-2 who has issued the request.

On the other hand, in steps S2081 and S2082, the CPU 010 performs control such that the captured image after receiving the notification of steps S2071 and S2072 is encoded by the coding unit 004 to be output to the administrator client 200-1.

In step S209, when the camera control unit 009 receives the information of the panning/tilting position, a current position of the captured image in the camera view illustrated in FIG. 3 is calculated based on the received panning/tilting position and the zoom position stored by the camera control unit 009. The camera control unit 009 determines a position at which the mask image is to be superimposed on the captured image by using the position of the calculated captured image and the information of the superimposed region to be superimposed with the mask image set in the initial setting.

For example, when the coordinates of the lower left apex O of the captured image (not illustrated) in the current image capturing direction are represented by (LLX, LLY) in FIG. 3, the position of the lower left apex of a mask image Min the captured image is represented by (LLx−LLX, LLy−LLY), where the apex O is an origin (0, 0). The positions of the other apexes of the mask image in a case where the apex O of the captured image is regarded as the origin can be acquired in a similar manner. As described above, the position at which the mask image is superimposed on the captured image can be determined. The above-described method is a mere example and thus any method can be employed as far as the position at which the mask image is superimposed on the captured image can be determined by the method. In the above example, the origin is the apex O. However, the position of the apex regarded as the origin may be any point on the captured image.

The camera control unit 009 controls the image processing unit 003 such that the mask image is superimposed on the calculated position on the captured image. The image processing unit 003 superimposes the mask image on a region on the captured image according to the image capturing direction defined by the drive control unit 007 according to control of the camera control unit 009.

In step S211, when the image on which the mask image is superimposed becomes ready to be output, the camera control unit 009 transmits the mask setting completion notification to the CPU 010. In step S2083, the CPU 010 controls the coding unit 004 to encode the image after step S2073 in order to transmit the image to the network 013 and controls the communication control unit 005 to transmit the image data of the image to each client via the network 013. The image data is transmitted to both of the general client 200-2 and the administrator client 200-1.

In the present exemplary embodiment, the image data can be transmitted in response to the image transmission request received from the clients 200 connected to the network 013. Alternatively, the image data may be transmitted independent from the image transmission request from the clients 200. In this case, when the CPU 010 receives the output notification to output the captured image from the camera control unit 009, the CPU 010 determines whether the captured image having received the notification can be distributed to each of the administrator client 200-1 and/or the general client 200-2, thereby controlling the transmission of the captured image.

In the present sequence, the CPU 010 superimposes the mask image on the captured image having received the information of the panning/tilting position from the drive control unit 007 to output the resulting image to the network 013. However, the timing to start outputting the captured image is not limited to the above timing, but the captured image may be output at any time after the detection unit 032 detects that the image capturing direction of the camera 100 reaches the reference directions. For example, the captured image may be started to be output after the detection unit 032 detects that the image capturing direction reaches the reference directions and after the driving unit 008 drives the camera 100 in a predetermined image capturing direction. The predetermined image capturing direction may be, for example, the image capturing direction at a time when the driving unit 008 starts driving to search for the reference directions (step S205 in FIG. 2).

The sequence at the time at which the power is turned on is described above. However, also in a case where the reference direction for panning and the reference direction for tilting are searched for according to an instruction from the outside, for example, via the network 013, the image data can be controlled to be transmitted until the mask image is set according to the same sequence.

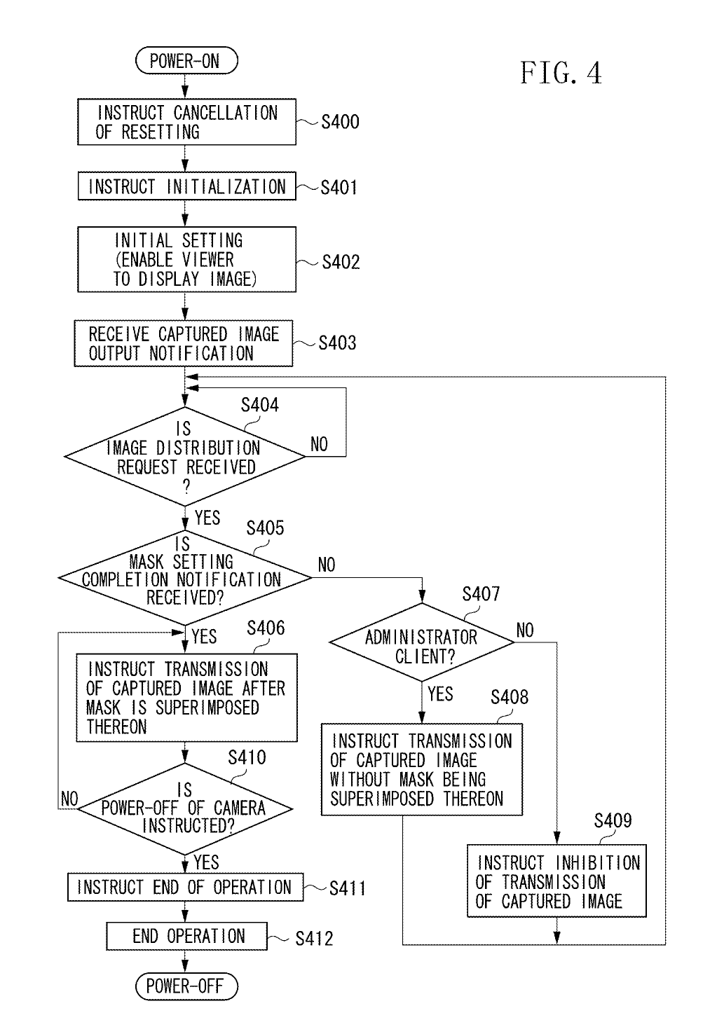

An operation of the CPU 010 in the present sequence is described below with reference to the flow chart of FIG. 4. The processing flow of FIG. 4 illustrates a program for causing the CPU 010 to execute the steps illustrated in FIG. 4. The CPU 010 reads out the program from the ROM 011 and executes the read-out program. Alternatively, the processing flow of FIG. 4 may be executed by hardware.

When the power is turned on, in step S400, the CPU 010 instructs the camera control unit 009 and the drive control unit 007 to cancel the resetting. In step S401, the CPU 010 issues the initialization instruction to the drive control unit 007. In step S402, the CPU 010 makes an initial setting with respect to the camera control unit 009. The initial setting includes processing in which the client causes the camera 100 to provide configuration information of the setting operation screen to the client. In other words, the CPU 010 performs processing for reading out the configuration information of the setting operation screen preliminary stored in the ROM 011 to permit provision of the configuration information to the client. With the processing, the client can access the camera 100 to open the administrator viewer or the public viewer via the setting operation screen displayed on the web browser. As described above, the initial setting includes processing for enabling the client to display the viewer.

The CPU 010 can make a plurality of initial settings with respect to the camera control unit 009. In the flowchart of FIG. 4, a case where the CPU 010 makes the initial setting after receiving the initialization instruction is described. However, the CPU 010 may issue the initialization instruction to the camera control unit 009 after making more than one initial setting.

In step S403, the CPU 010 subsequently receives the notification to the effect that the captured image is ready to be output from the camera control unit 009. In step S404, the CPU 010 waits for the image distribution request from the clients 200. When the CPU 010 receives the image distribution request from the clients 200 (YES in step S404), then in step S405, the CPU 010 determines whether the CPU 010 has already received a mask setting completion notification from the camera control unit 009. In a case where the CPU 010 has already received the mask setting completion notification (YES in step S405), then in step S406, the CPU 010 instructs the communication control unit 005 to transmit the captured image having received the notification in step S403 to the network 013 after encoding the captured image by the coding unit 004.

On the other hand, in a case where the CPU 010 has not received the mask setting completion notification yet (NO in step S405), then in step S407, the CPU 010 determines whether the client who has issued the image transmission request is the administrator client 200-1 or the general client 200-2. In a case where the administrator client 200-1 has issued the image transmission request by using the administrator viewer (YES in step S407), then in step S408, the CPU 010 instructs the communication control unit 005 to transmit the captured image on which the mask image is not superimposed in the image processing unit 003 to the network 013 after encoding the captured image by the coding unit 004.

On the other hand, in a case where the general client 200-2, who does not use the administrator viewer, has issued the image transmission request (NO in step S407), then in step S409, the CPU 010 performs control such that the captured image is not transmitted to the network 013 by preventing the captured image from being encoded by the coding unit 004. Accordingly, the CPU 010 limits display of the captured image by regarding an entire region of the captured image as a restricted region. After step S408 or step S409, the CPU 010 repeats steps S404 and S405.

In the present exemplary embodiment, a case where the CPU 010 performs the image distribution in response to the image distribution request is described. However, the CPU 010 may perform the image distribution independent from the image distribution request. In this case, when the CPU 010 receives the output notification notifying the output of the captured image in step S403, the CPU 010 advances the processing to step S405. In a case where the CPU 010 has not received the mask setting completion notification (NO in step S405), the CPU 010 transmits the captured image after receiving the notification to the administrator client 200-1, whereas the CPU 010 does not transmit the captured image after receiving the notification to the general client 200-2. Then, the CPU 010 repeats steps S403 and S405.

In step S406, after the CPU 010 issues the captured image transmission instruction, then in step S410, the CPU 010 determines whether the instruction to disconnect the power to the camera 100 is issued. In a case where the instruction to disconnect the power is made via the network 013 or directly to the camera 100 by the user (YES in step S410), then in step S411, the CPU 010 issues an operation end instruction to each block connected to the CPU 010, e.g., the camera control unit 009. In step S412, the CPU 010 ends the operation. On the other hand, in a case where the instruction to disconnect the power is not made (NO in step S410), the CPU 010 repeats steps S406 and S410.

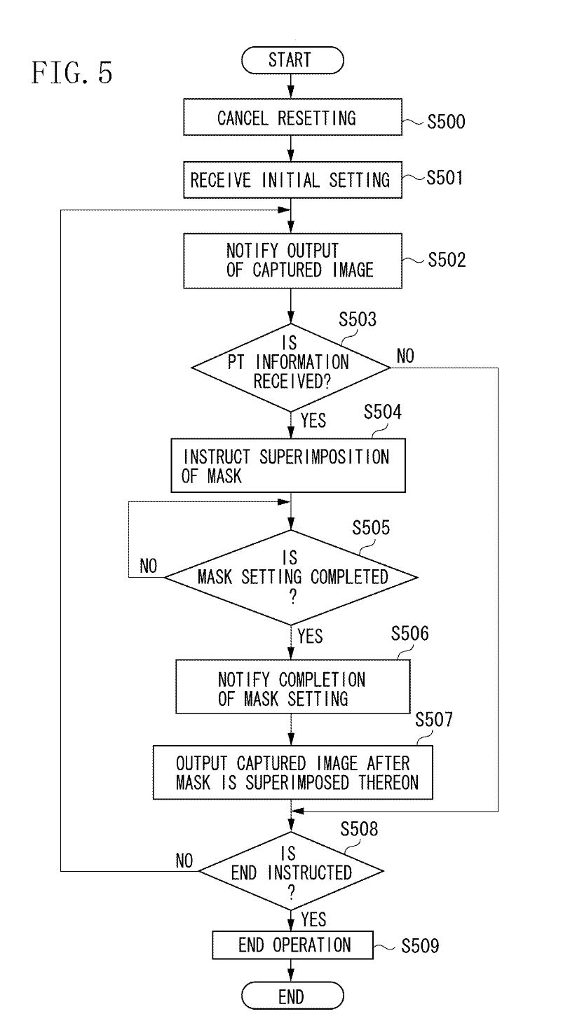

An operation of the camera control unit 009 in the sequence illustrated in FIG. 2 is described below with reference to FIG. 5. In a case where a function of the camera control unit 009 is realized by using a processor and a memory, the processing flow of FIG. 5 illustrates a program for causing the processor to execute the steps illustrated in FIG. 5. The processor is a computer that executes the program read out from the memory. The memory is a storage medium that stores the program so as to be readable by the processor. In an embodiment in which the CPU 010 controls the operation of the camera control unit 009, the processing flow of FIG. 5 is a program that causes the CPU 010 to execute the steps illustrated in FIG. 5. The CPU 010 reads out the program from the ROM 011 to execute it, thereby controlling the camera control unit 009. Alternatively, the processing flow of FIG. 5 may be executed by hardware.

In step S500, when the camera control unit 009 receives a resetting cancellation instruction from the CPU 010, the camera control unit 009 cancels the resetting. In step S501, the camera control unit 009 receives the initial setting from the CPU 010 and makes a setting with respect to each block controlled by the camera control unit 009 according to the initial setting. When an object image is captured by the imaging unit 002 based on the initial setting and the captured image becomes ready to be output, then in step S502, the camera control unit 009 issues a captured image output notification to the CPU 010.

In a case where the camera control unit 009 receives the information of the image capturing direction (i.e., information of the panning/tilting position) from the drive control unit 007 (YES in step S503), then in step S504, the camera control unit 009 causes the image processing unit 003 to superimpose the mask image based on the received information of the image capturing direction. When the image processing unit 003 completes the mask setting (YES in step S505), then in step S506, the camera control unit 009 notifies the mask setting completion notification to the CPU 010. The camera control unit 009 outputs the captured image on which the mask image is superimposed in the image processing unit 003 to the coding unit 004.

When the camera control unit 009 receives an end instruction from the CPU 010 (YES in step S508), the camera control unit 009 ends the operation. In a case where the camera control unit 009 does not receive the end instruction (NO in step S508), the camera control unit 009 repeats steps S502 through S508.

As described above, the present exemplary embodiment is configured such that the captured image captured during a period after the driving unit 008 starts driving to search for the reference directions and before the detection unit 032 detects that the image capturing direction reaches the reference directions is not transmitted to the general client 200-2. With respect to the captured image captured after the detection unit 032 detects that the image capturing direction of the camera 100 reaches the reference directions, an accurate image capturing direction can be defined based on the drive amount of the driving unit 008 from the reference directions. Therefore, the image processing unit 003 can superimpose the mask image on a set superimposed region accurately.

In the present exemplary embodiment, during a detection period after the driving unit 008 starts driving to search for the reference directions and before the detection unit 032 detects that the image capturing direction reaches the reference directions, control is performed to permit providing the information to the client, the information composing the screen that enables the client to display the viewer.

The present exemplary embodiment is configured such that the captured image is not transmitted to the general client 200-2 before the mask image can be superimposed on the superimposed region accurately. Therefore, the captured image in which the privacy of an object is protected can be transmitted also during a period in which the camera 100 searches for the reference directions for defining the image capturing direction. In the present exemplary embodiment, the captured image captured after the detection unit 032 detects that the image capturing direction of the camera 100 reaches the reference directions can be transmitted after the mask image is superimposed on an accurate position thereof.

In the above-described exemplary embodiment, the CPU 010 does not output the captured image to the general client 200-2 before the CPU 010 receives the mask setting completion notification from the camera control unit 009. However, the CPU 010 may output a substitute image such as a color bar chart instead of the captured image not to be output. In this case, when the CPU 010 receives the captured image before receiving the mask setting completion notification, the CPU 010 reads out data of the substitute image, i.e., an encoded substitute image, from the ROM 011 without using the received captured image and transmits the data thereof to the network 013 by controlling the communication control unit 005.

Alternatively, in the above-described exemplary embodiment, the CPU 010 does not transmit the captured image to the general client 200-2 before the CPU 010 receives the mask setting completion notification from the camera control unit 009. At that time, the captured image that is ever captured and stored in the ROM 011 may be output instead of the untransmitted captured image. In this case, the CPU 010 stores the captured image that is encoded by the coding unit 004 and output to the network 013 from the coding unit 004 before the operation is ended in step S412 of the flow chart of FIG. 4 and ends the operation thereof. The captured image to be stored in the ROM 011 is the captured image on which the mask image is adequately superimposed according to the setting.

In a case where the camera 100 is turned on again, if the CPU 010 receives a captured image output notification before receiving the mask setting completion notification (NO in step S405 in FIG. 4), the CPU 010 reads out the captured image, which is ever captured to be encoded, from the ROM 011. The CPU 010 controls the communication control unit 005 to transmit the image data of the captured image that is ever captured and read out to the general client 200-2.

After outputting the substituted image and the captured image ever captured, the CPU 010 limits display of the captured image captured during a detection period after the driving unit 008 starts driving to search for the reference directions and before the detection unit 032 detects that the image capturing direction reaches the reference directions with respect to the general client 200-2. As described above, the CPU 010 can limit display of all of the captured image captured during the detection period. Accordingly, even while the camera 100 searches for the reference directions for defining the image capturing direction, the CPU 010 can transmit the captured image in which the privacy of the object is protected. Since the image having already been encoded is output as the substitute image, it is not necessary to encode the captured image. As a result thereof, the processing by the CPU 010 becomes simple, resulting in achieving power-saving in the operation thereof. Independent from whether the mask setting is completed, since the image distribution can be performed with respect to the general client 200-2, an effect that a secure feeling can be provided to the user of the general client 200-2 since a state that the camera 100 is operating normally can be known immediately after the startup of the camera 100.

The CPU 010 may output the captured image having received the captured image output notification in steps S2071 and S2072 in FIG. 2 to the general client 200-2 after lowering the image quality of the captured image and encoding it.

When the CPU 010 receives the captured image in steps S2071 and S2072, the CPU 010 controls the coding unit 004 to encode the captured image in order to transmit the captured image to the network 013. The CPU 010, then, controls the communication control unit 005 to transmit the image data of the encoded image to the network 013. At that time, the CPU 010 encodes the captured image so as to lower the image quality thereof. The lowered image quality here means that the image includes less information quantity in comparison with a reference image. The information quantity means, for example, a quantity of information about luminance or color-difference of the image.

The CPU 010 can change the image quality by, for example, changing a quantization scale to be used in quantization in the encoding processing. The quantization scale is a Q value, which is a value of a denominator to be used in a division process for quantization in the encoding processing. Larger quantization scale value lowers the image quality more. Before the CPU 010 receives the mask setting completion notification, the CPU 010 can lower the image quality of the captured image to encode the captured image by enlarging the value of the quantization scale than the value of the quantization scale after receiving the mask setting completion notification to encode the captured image. The method in which the CPU 010 changes the image quality is not limited to the above but may be any method. Accordingly, the CPU 010 can limit display of all of the captured images captured during the detection period.

When the CPU 010 receives the mask setting completion notification in step S211, the CPU 010 encodes the captured image by applying the encoding quality that is preliminary set, for example, in the initial setting. The CPU 010 controls the communication control unit 005 to transmit the data of the encoded image to the network 013.

Accordingly, the CPU 010 limits display of the captured image, displayed on the general client 200-2, captured during a period after the driving unit 008 starts driving to search for the reference directions and before the detection unit 032 detects that the image capturing direction of the camera 100 reaches the reference directions. As described above, the captured image in which the privacy of an object is protected can be transmitted even while the camera 100 searches for the reference directions for defining the image capturing direction. Since the CPU 010 can perform the image distribution independent from whether the mask setting is completed, so that a state that the camera 100 is normally operating is known immediately after starting the camera 100. As a result thereof, a secure feeling can be provided to the user.

In the present exemplary embodiment, a case where the display of the captured image captured before the detection unit 032 detects the reference directions is limited with respect to the general client 200-2 is described. However, the present invention is not limited to the above. The display of the captured image captured before the detection unit 032 detects the reference directions may be limited with respect to both of the administrator client 200-1 and the general client 200-2.

The present exemplary embodiment performs control to permit provision of information for composing a screen that enables the client to display the viewer to the client during a detection period after the driving unit 008 starts driving to search for the reference directions and before the detection unit 032 detects that the image capturing direction reaches the reference directions.

As described above, after the detection unit 032 detects that the image capturing direction reaches the reference directions, the camera 100 can immediately distribute the captured image to the client.

According to the present exemplary embodiment, in a case where the camera 100 transmits the captured image in response to the image transmission request from the client, the camera 100 can transmit the captured image while protecting the privacy of an object even while the camera 100 searches for the reference directions for defining the image capturing direction.

In a second exemplary embodiment of the present invention, a case where the CPU 010 receives a predetermined substitute image or an image obtained by processing the captured image from the camera control unit 009 to output it to the general client 200-2 even before the CPU 010 receives the mask setting completion notification is described below.

Initially, a configuration of the second exemplary embodiment different from that of the first exemplary embodiment is described below. In the second exemplary embodiment, the camera control unit 009 outputs the substitute image instead of the captured image captured by the imaging unit 002 to the CPU 010 before the detection unit 032 detects that the image capturing direction of the camera 100 reaches the reference directions and the camera control unit 009 receives the information of the image capturing direction from the drive control unit 007.

The CPU 010 according to the second exemplary embodiment encodes the substitute image received from the camera control unit 009 in step S409 in FIG. 4 to transmit the data thereof to the general client 200-2 even before the CPU 010 receives the mask setting completion notification from the camera control unit 009. The configurations other than the above are similar to those of the first exemplary embodiment, so that descriptions thereof are omitted here.

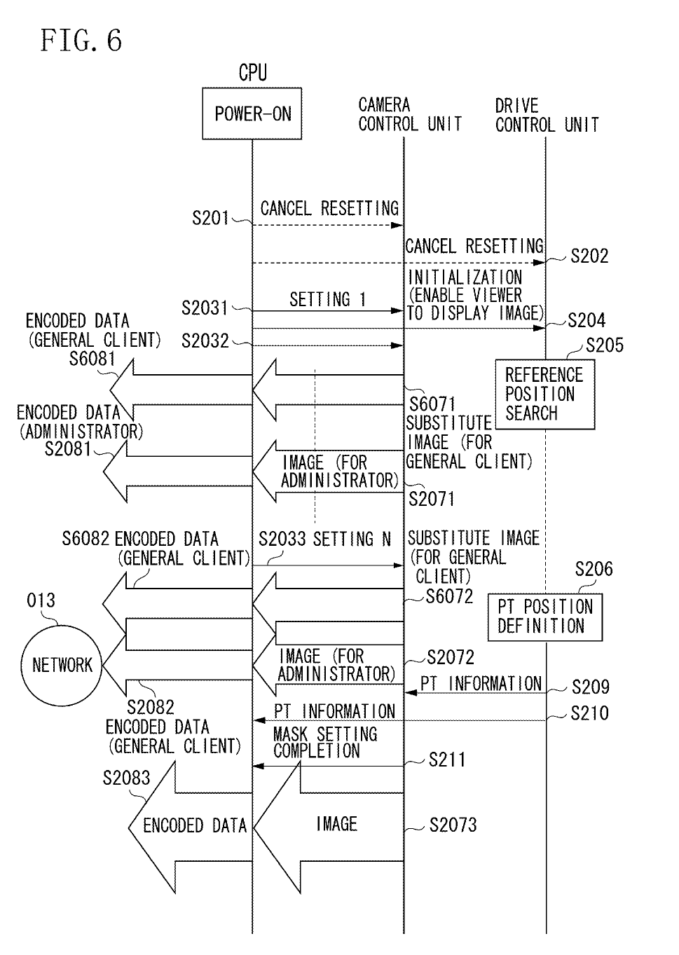

An operation of the camera 100 when the power thereof is turned on according to the second exemplary embodiment is described below with reference to FIG. 6. Processing similar to the operation described in the first exemplary embodiment is provided with the same symbol and a description thereof is omitted here. Performing the processing different from that of the first exemplary embodiment is described below.

After the power is turned on, the camera control unit 009 sequentially receives the initial setting from the CPU 010 and notifies a message to the effect that the image is output when the image becomes ready to be output to the CPU 010. In steps S6071 and S6072, the camera control unit 009 controls the image processing unit 003 to output, for example, an image of a color bar chart as the substitute image instead of the image output from the imaging unit 002 as the image to be distributed to the general client 200-2 before the mask setting is completed. An image preliminary stored in the ROM 011 can be read out by the camera control unit 009 to be used as the substitute image. In steps S2071 and S2072, the camera control unit 009 also outputs the captured image to be distributed to the administrator client 200-1 independent from the image to be distributed to the general client 200-2.

When the CPU 010 receives the substitute image in step S6071 and step S6072, then in steps S6081 and S6082, the CPU 010 controls the coding unit 004 to encode the image and further controls the communication control unit 005 to transmit data of the encoded image to the general client 200-2. Similar to the first exemplary embodiment, the CPU 010 transmits the encoded captured image to the administrator client 200-1.

When the camera control unit 009 receives panning/tilting information in step S209, the camera control unit 009 instructs the image processing unit 003 to output the captured image in which the mask image is superimposed on the superimposed region set in the initial setting. After the detection unit 032 detects that the image capturing direction of the camera 100 reaches the reference directions, the drive control unit 007 defines the panning/tilting position of the camera 100 based on the detected reference directions and outputs the information of the panning/tilting position to the camera control unit 009. Therefore, the camera control unit 009 can receive the information of the panning/tilting position with respect to the captured image captured after the detection unit 032 detects that the image capturing direction of the camera 100 reaches the reference directions. The camera control unit 009 superimposes the mask image on the superimposed region of the captured image having received the information of the panning/tilting position and outputs the resulting image from the image processing unit 003 to the coding unit 004. In step S2083, when the CPU 010 receives a notification to the effect that the captured image is output from the camera control unit 009, the CPU 010 encodes the captured image to transmit it to the administrator client 200-1 and the general client 200-2.

In other words, in steps S6081 and S6082, the captured image captured before the detection unit 032 detects that the image capturing direction of the camera 100 reaches the reference directions is substituted with the image of the color bar chart to be transmitted to the general client 200-2. On the other hand, in step S2083, the captured image captured after the detection unit 032 detects that the image capturing direction of the camera 100 reaches the reference directions is transmitted to the administrator client 200-1 and the general client 200-2 after the mask image is superimposed on the captured image in the image processing unit 003. As described above, the camera 100 according to the present exemplary embodiment controls display of the captured image captured during a period after the driving unit 008 starts driving to search for the reference directions and before the detection unit 032 detects that the image capturing direction of the camera 100 reaches the reference directions.

How to superimpose the mask image in the image processing unit 003 according to the second exemplary embodiment is similar to the processing described in the first exemplary embodiment, so that a description thereof is omitted here. The transmission of the image data can be performed, for example, in response to the image transmission request received from the client connected to the network 013.

In the second exemplary embodiment, the CPU 010 transmits the substitute image to be transmitted to the general client 200-2 in step S409 described with reference to FIG. 4 in the first exemplary embodiment. Accordingly, the CPU 010 limits display of all of the captured images captured during the detection period.

In the second exemplary embodiment, in a case where the camera control unit 009 has not received the panning/tilting information in step S503 described with reference to FIG. 5 in the first exemplary embodiment, the camera control unit 009 reads out the substitute image from the ROM 011 to output it to the coding unit 004 as the image to be distributed to the general client 200-2.

As described above, the CPU 010 performs control such that the captured image captured during a period after the driving unit 008 starts driving to search for the reference directions and before the detection unit 032 detects that the image capturing direction of the camera 100 reaches the reference directions is not transmitted to the general client 200-2.

Accordingly, in the second exemplary embodiment, the camera 100 can transmit the captured image in which the privacy of an object is protected even while the camera 100 searches for the reference directions for defining the image capturing direction. According to the present exemplary embodiment, the image distribution can be performed independent from whether the information of the panning/tilting position is defined, so that a secure feeling can be provided to the user since a state that the camera 100 is operating normally is known immediately after the camera 100 is started.

In the second exemplary embodiment, the camera control unit 009 outputs the color bar chart in steps S3071 and S3072 as the substitute image. However, the camera control unit 009 may output the image in which the image processing unit 003 superimposes the mask image over the entire captured image captured by the imaging unit 002 in addition to the above. Alternatively, the camera control unit 009 may output an image after the image processing unit 003 performs blurring or pixelization on the entire captured image captured in the imaging unit 002. In this case, during a period after the camera 100 is turned on and before the camera control unit 009 receives the panning/tilting information, the camera control unit 009 superimposes the mask image on the entire captured image or performs blurring or pixelization on the entire captured image.

The superimposition of the mask image, blurring, or pixelization is not necessarily provided to the entire screen but may be provided in a range as far as the contents of the captured image is not recognized by viewers. The display of the captured image may be limited by setting, for example, a part of the captured image as the restricted region. As described above, the CPU 010 limits display of an entire or partial region of the captured image captured during the detection period.

When the CPU 010 receives the panning/tilting information in step S209, the CPU 010 instructs the image processing unit 003 to output the captured image after a mask image is superimposed on a position set by the initial setting in the captured image.

Accordingly, the substitute image can be generated by using the function of superimposing the mask image, the function of blurring, or the function of pixelization of the image processing unit 003, as they are, without requiring an additional resource of the image processing.

When the camera control unit 009 outputs the above-described color bar chart and the substitute image such as the captured image on which the mask image is superimposed and the captured image having been subjected to pixelization, the camera control unit 009 can superimpose a message alerting the user on the image. For example, in steps S6071 and S6072, in a case where the camera control unit 009 outputs the captured image having been subjected to pixelization, the camera control unit 009 can superimpose a message of, for example, “a pixelized image is distributed since the camera is in the initialization processing” on the image.

To achieve the superimposition of the message, the CPU 010 makes a setting of the OSD with respect to the camera control unit 009 after the power is turned on. The setting contents include, for example, literatures, colors, fonts, sizes, and display positions of the message. When the camera control unit 009 receives the setting of the OSD from the CPU 010, the camera control unit 009 controls the image processing unit 003 to superimpose the alerting literature alerting to the user on the output image.

When the CPU 010 receives the mask setting completion notification in step S211, the CPU 010 transmits an OSD setting cancellation notification for ending the superimposition of the message to the camera control unit 009. Upon receiving the OSD setting cancellation notification, the camera control unit 009 performs control so as not to superimpose the message on the image to be output. As a result thereof, the alerting message alerting to the user is not superimposed on the subsequent images any more.

With the above configuration, character information shows that the substitute image is distributed because the camera 100 is in the mask image setting process, which provides a secure feeling to the user.

In the above-described exemplary embodiment, a case where display of the captured image is limited to the general client 200-2 is described, to which, however, the present invention is not limited. The display of the captured image captured before the detection unit 032 detects the reference directions may be limited to both of the administrator client 200-1 and the general client 200-2.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-110642 filed May 17, 2011, which is hereby incorporated by reference herein in its entirety.

What is claimed is:

1. An image transmission apparatus configured to transmit a captured image captured by an imaging unit to a display apparatus via a network, the image transmission apparatus comprising:
a detection unit configured to detect that an image capturing direction of the imaging unit changed by a changing unit configured to change the image capturing direction reaches a reference direction;
a limiting unit configured to limit display of an entire or partial region of the captured image;
a providing unit configured to provide, to the display apparatus, information for composing a screen to be used for displaying the captured image on the display apparatus via the network; and
a control unit configured to cause the limiting unit to limit display of an entire or partial region of the captured image captured during a detection period after the changing unit starts changing of the image capturing direction and before the detection unit detects that the image capturing direction reaches the reference direction, and to allow the providing unit to provide the information for composing the screen during a period including the detection period.

2. The image transmission apparatus according to claim 1, further comprising:
an identifying unit configured to identify the image capturing direction after being changed based on a changing amount by which the changing unit changes the image capturing direction from the reference direction;
a storing unit configured to store region information indicating a restricted region, the restricted region being preliminary designated not to be displayed in an image capturing region of which the imaging unit can capture an image; and
a restricting unit configured to restrict display of the restricted region based on the region information stored in the storing unit and the image capturing direction identified by the identifying unit;
wherein the control unit causes a first display apparatus to display the captured image captured during the detection period after the changing unit starts changing of the image capturing direction and before the detection unit detects that the image capturing direction reaches the reference direction, the first display apparatus having an authority for displaying the captured image in which display of the restricted region is not restricted, and causes the limiting unit to limit display of an entire or partial region of the captured image captured during the detection period with respect to a second display apparatus that does not have the authority; and
wherein the control unit performs transmission control such that an image in which the restricting unit restricts display of the restricted region in the captured image captured after the detection unit detects that the image capturing direction reaches the reference direction is transmitted to at least the second display apparatus.

3. The image transmission apparatus according to claim 1, wherein the limiting unit limits display of a predetermined limited region that is larger than a restricted region preliminary set to limit display of a partial region of the captured image and that includes the restricted region.

4. The image transmission apparatus according to claim 1, wherein the limiting unit limits display of the captured image such that a predetermined image is transmitted to the display apparatus instead of the captured image captured during the detection period.

5. The image transmission apparatus according to claim 4, wherein the limiting unit limits display of the captured image such that a captured image previously captured by the imaging unit is transmitted as the predetermined image to the display apparatus.

6. The image transmission apparatus according to claim 1, wherein the limiting unit limits display of the captured image such that an image obtained by superimposing a mask image on the captured image captured during the detection period or an image obtained by performing pixelization on the captured image is transmitted to the display apparatus.

7. The image transmission apparatus according to claim 1, further comprising:
an encoding unit configured to encode the captured image;
wherein the limiting unit limits display of the captured image by controlling the encoding unit such that an image quality of an image obtained by encoding the captured image captured during the detection period becomes lower than an image quality of an image obtained by encoding the captured image captured after the detection unit detects that the image capturing direction reaches the reference direction, and by transmitting the captured image encoded by the encoding unit to the display apparatus.

8. The image transmission apparatus according to claim 1, wherein the limiting unit causes the display apparatus to display a massage indicating that the changing unit is in an initialization process on the captured image when the limiting unit limits display of the captured image such that an image in which display of an entire or partial region of the captured image captured during the detection period is limited is transmitted to the display apparatus.

9. An image transmission method for transmitting a captured image captured by an imaging unit to a display apparatus via a network, the image transmission method comprising:
detecting whether an image capturing direction of the imaging unit reaches a reference direction;
limiting display of an entire or partial region of the captured image captured during a detection period after the image capturing direction is started to be changed and before a state that the image capturing direction reaches the reference direction is detected; and
allowing providing, to the display apparatus during the detection period, information for composing a screen to be used for displaying the captured image on the display apparatus via the network.

10. The image transmission method according to claim 9, further comprising:
identifying the image capturing direction after being changed based on a changing amount by which the image capturing direction is changed from the reference direction;
storing region information indicating a restricted region in which display of a preliminary designated region in an image capturing region that the imaging unit can capture is to be restricted;
restricting display of the restricted region based on the region information and the identified image capturing direction;
causing a first display apparatus to display the captured image captured during the detection period after a change of the image capturing direction is started and before a state that the image capturing direction reaches the reference direction is detected, the first display apparatus having an authority to display the captured image in which display of the restricted region is not restricted, and limiting display of an entire or partial region of the captured image captured during the detection period with respect to a second display apparatus that does not have the authority; and
transmitting, to at least the second display apparatus, an image in which display of the restricted region is restricted with respect to the captured image captured after the state that the image capturing direction reaches the reference direction is detected.

11. The image transmission method according to claim 9, further comprising:
limiting display of the captured image such that a captured image previously captured by the imaging unit is transmitted to the display apparatus as a predetermined image instead of the captured image captured during the detection period.

12. A non-transitory computer readable storage medium storing a program that causes a computer to execute a method, the computer being configured to transmit a captured image captured by an imaging unit to a display apparatus via a network, the method comprising:
detecting whether an image capturing direction of the imaging unit reaches a reference direction;
limiting display of an entire or partial region of the captured image captured during a detection period after the image capturing direction is started to be changed and before a state that the image capturing direction reaches the reference direction is detected; and
allowing providing, to the display apparatus during the detection period, information for composing a screen to be used for displaying the captured image on the display apparatus via the network.

13. The non-transitory computer readable storage medium according to claim 12, wherein the method further comprises:
identifying the image capturing direction after being changed based on a changing amount by which the image capturing direction is changed from the reference direction;
storing region information indicating a restricted region in which display of a preliminary designated region in an image capturing region that the imaging unit can capture is to be restricted;
restricting display of the restricted region based on the region information and the identified image capturing direction;
causing a first display apparatus to display the captured image captured during the detection period after a change of the image capturing direction is started and before a state that the image capturing direction reaches the reference direction is detected, the first display apparatus having an authority to display the captured image in which display of the restricted region is not restricted, and limiting display of an entire or partial region of the captured image captured during the detection period with respect to a second display apparatus that does not have the authority; and
transmitting, to at least the second display apparatus, an image in which display of the restricted region is restricted with respect to the captured image captured after the state that the image capturing direction reaches the reference direction is detected.

14. The non-transitory computer readable storage medium according to claim 12, wherein the method further comprises:
limiting display of the captured image such that a captured image previously captured by the imaging unit is transmitted to the display apparatus as a predetermined image instead of the captured image captured during the detection period.
